(19) United States
(12) Patent Application Publication
(10) Pub. No.: US 2023/0023426 A1
(43) Pub. Date: Jan. 26, 2023

(54) STEERING GUIDE TORQUE CONTROL DEVICE FOR VEHICLE

(71) Applicant: TOYOTA JIDOSHA KABUSHIKI KAISHA, Toyota-shi (JP)

(72) Inventors: Takeshi Hamaguchi, Seto-shi (JP); Shintaro Saigo, Nisshin-shi (JP); Shusaku Sugamoto, Toyota-shi (JP)

(73) Assignee: TOYOTA JIDOSHA KABUSHIKI KAISHA, Toyota-shi (JP)

(21) Appl. No.: 17/857,576

(22) Filed: Jul. 5, 2022

(30) Foreign Application Priority Data
Jul. 16, 2021 (JP) 2021-117967

(51) Int. Cl. B62D 15/02

(52) U.S. Cl. CPC B62D 15/025

(57) ABSTRACT

A control unit configured to control a reaction force actuator that applies steering guide torque to a steering wheel calculates a target steering angle for causing a vehicle to travel along a curve, calculates target steering guide torque based on a deviation between the target steering angle and an actual steering angle, modifies the target steering guide torque such that the target steering guide torque is larger as an index value indicating at least one of the number of times or an integrated time in which a difference between a magnitude of the actual steering angle and a magnitude of the target steering angle exceeds a reference value is larger, and controls the reaction force actuator such that the steering guide torque becomes the target steering guide torque.

### CROSS-REFERENCE TO RELATED APPLICATION

This application claims priority to Japanese Patent Application No. 2021-117967 filed on Jul. 16, 2021, incorporated herein by reference in its entirety.

### BACKGROUND

### 1. Technical Field

The present disclosure relates to a steering guide torque control device for a vehicle, such as an automobile.

### 2. Description of Related Art

As a steering reaction force torque control device for a vehicle, such as an automobile, for example, there is a known steering reaction force torque control device configured such that an appropriate steering operation amount is predicted based on a detection result of an external sensor and when a steering operation amount by a driver corresponding to a predicted point in time of the appropriate steering operation amount is not within an appropriate steering operation amount range, steering reaction force torque is made larger than conventional until the steering operation amount reaches the appropriate steering operation amount range, as described in Japanese Unexamined Patent Application Publication No. 2019-209844 (JP 2019-209844 A) below.

When the steering operation amount changes from within the appropriate steering operation amount range to outside the range, the steering reaction force torque acts as steering reaction force torque that opposes a steering operation. When the steering operation amount reaches from outside the appropriate steering operation amount range to within the range, the steering reaction force torque acts as steering reaction force torque that urges the driver to perform the steering operation. Therefore, the steering reaction force torque control device described in JP 2019-209844 A below may be referred to as a steering guide torque control device.

As the steering guide torque control device, there is a known steering guide torque control device that calculates a target steering angle for causing the vehicle to travel along a curve based on a curve curvature, detected by a camera sensor, of a traveling road in front of the vehicle, calculates target steering guide torque for guiding driver's steering such that an actual steering operation amount is within a predetermined range of the steering operation amount including a target steering operation amount based on a deviation between a target steering angle including a look-ahead time and an actual steering angle, and controls a torque applying device such that steering guide torque becomes the target steering guide torque.

With the steering reaction force torque control device and the steering guide torque control device as described above, it is possible to urge the driver to perform the steering operation such that the actual steering angle becomes the target steering angle when the vehicle travels on the curve of the traveling road. Accordingly, it is possible to provide steering assistance such that the steering operation amount by the driver becomes the appropriate steering operation amount while maintaining driver's sense of independence in steering.

### SUMMARY

In the steering guide torque control device, the target steering angle is calculated as a steering angle for causing the vehicle to travel along the curve based on the curve curvature of the traveling road in front of the vehicle. However, the driver may want curve traveling different from the curve traveling by the target steering angle. For example, the target steering angle is calculated such that the vehicle performs the curve traveling along a center of a lane, but the driver may try to perform the curve traveling in a pattern such as out-in-out or large turn.

When the driver desires the curve traveling different from the curve traveling by the target steering angle, the steering operation is performed such that the actual steering angle is different from the target steering angle. Therefore, when the driver performs additional steering such that the actual steering angle is separated from the target steering angle, the driver inevitably feels a sense of discomfort of increasing in steering reaction force due to the steering guide torque.

A main object of the present disclosure is to provide an improved steering guide torque control device configured to reduce a risk that a driver feels a sense of discomfort of increasing in steering reaction force due to steering guide torque when a vehicle performs curve traveling.

A first aspect of the disclosure relates to a steering guide torque control device for a vehicle (10) including a steering input member (steering wheel 20) that is subjected to steering operation by a driver, a turning device (18) that turns turning wheels (28FR, 28FL) according to a steering operation amount applied to the steering input member, a torque applying device (reaction force actuator 24) that applies steering guide torque (Tsg) to the steering input member, a control unit (ECU 14) that controls the torque applying device, and an imaging device (camera sensor 46) that acquires an image in front of the vehicle. The control unit is configured to estimate a curvature (ρpre) of a lane in front of the vehicle for causing the vehicle to travel along the lane based on the image acquired by the imaging device, calculate a target steering operation amount (θt) based on the curvature of the lane, calculate target steering guide torque (Tsgt) that guides the driver to steer such that an actual steering operation amount (θ) is within a predetermined range of the steering operation amount including the target steering operation amount based on a deviation (Δθ) between the target steering operation amount and the actual steering operation amount, and perform steering guide torque control to control the torque applying device (reaction force actuator 24) such that the steering guide torque becomes the target steering guide torque.

The control unit (ECU 14) is configured to obtain an index value (Nin) indicating at least one of the number of times or an integrated time in which a difference between a magnitude of the actual steering operation amount (θ) and a magnitude of the target steering operation amount (θt) exceeds a reference value (θa) within a determination time (Tc) up to the present and modify the target steering guide torque (Tsgt) according to the index value such that a magnitude of the target steering guide torque becomes smaller as the index value is larger (S10 to S40).

With the above configuration, the torque applying device is controlled such that the target steering operation amount is calculated based on the curvature of the lane in front of the vehicle for causing the vehicle to travel along the lane, the target steering guide torque for guiding the driver to steer is calculated such that the actual steering operation amount is within the predetermined range of the steering operation amount including the target steering operation amount based on the deviation between the target steering operation amount and the actual steering operation amount, and the steering guide torque becomes the target steering guide torque. Accordingly, it is possible to apply the steering guide torque for causing the vehicle to travel along the lane to the steering input member and urge the driver to perform the steering operation such that the actual steering operation amount becomes the target steering operation amount.

Further, with the above configuration, the index value indicating at least one of the number of times or the integrated time in which the difference between the magnitude of the actual steering operation amount and the magnitude of the target steering operation amount exceeds the reference value within the determination time up to the present is obtained. Further, the target steering guide torque is modified according to the index value such that the magnitude of the target steering guide torque becomes smaller as the index value is larger. Accordingly, compared with a case where the target steering guide torque is not modified according to the index value, it is possible to reduce a risk that the driver feels a sense of discomfort of increasing in the steering reaction force due to the steering guide torque when the vehicle performs the curve traveling.

### Aspects of Disclosure

In one aspect of the present disclosure, the control unit (ECU 14) is configured to reduce a ratio of the target steering guide torque (Tsgt) to the deviation (Δθ) as the index value (Nin) is larger (S50 to S90).

According to the above aspect, the ratio of the target steering guide torque to the deviation is lower as the index value is larger. Accordingly, it is possible to lower the ratio of the target steering guide torque to the deviation as at least one of the number of times or the integrated time in which the difference between the magnitude of the actual steering operation amount and the magnitude of the target steering operation amount exceeds the reference value within the determination time up to the present is larger. Therefore, the magnitude of the target steering guide torque can be smaller as the tendency of the driver to perform the curve traveling different from the curve traveling by the target steering angle.

In another aspect of the present disclosure, the control unit (ECU 14) is configured to increasingly modify the magnitude of the target steering operation amount (θt) for a modification amount (Δθa×sign θt) that becomes larger as the index value (Nin) is larger (S60, S100).

According to the above aspect, the magnitude of the target steering operation amount is increasingly modified with the modification amount that becomes larger as the index value is larger. Accordingly, it is possible to reduce the magnitude of the target steering guide torque when the magnitude of the actual steering operation amount becomes larger than the magnitude of the target steering operation amount that is not increasingly modified.

Further, in another aspect of the present disclosure, the control unit (ECU 14) is configured to variably set the determination time (Tc) according to a frequency at which the vehicle (60) performs the curve traveling such that the determination time becomes longer as the frequency at which the vehicle performs curve traveling is lower (S40).

According to the above aspect, the determination time is variably set according to the frequency at which the vehicle performs the curve traveling such that the determination time becomes longer as the frequency at which the vehicle performs the curve traveling is lower. Accordingly, it is possible to calculate the index value as a value indicating the tendency of the driver to perform the steering operation such that the actual steering angle is different from the target steering angle, regardless of the number of curves on the traveling road.

Further, in another aspect of the present disclosure, the control unit (ECU 14) is configured to acquire information on a vehicle speed (V) and to variably set the reference value according to the vehicle speed such that the reference value (θa) becomes smaller as the vehicle speed is higher (S60).

In general, the steering angle when a vehicle performs the curve traveling is smaller as the turning radius of the curve is larger and the vehicle speed is higher. Further, the difference between the magnitude of the actual steering operation amount and the magnitude of the target steering operation amount becomes smaller as the vehicle speed is higher.

According to the above aspect, the reference value is variably set according to the vehicle speed such that the reference value becomes smaller as the vehicle speed is higher. Accordingly, it is possible to calculate the index value as the value indicating the tendency of the driver to perform the steering operation such that the actual steering angle is different from the target steering angle, regardless of the magnitude of a turning radius of the curve.

Further, in another aspect of the present disclosure, the control unit (ECU 14) is configured to execute autonomous turning control to autonomously turn the turning wheels (28FR, 28FL) by the turning device (18) such that the vehicle (60) travels along the lane even though the steering input member (steering wheel 20) is not subjected to the steering operation by the driver and to stop the autonomous turning control and start the steering guide torque control when the steering operation of the steering input member by the driver is determined to be started during the execution of the autonomous turning control (S20, S40 to S140).

According to the above aspect, the autonomous turning control to autonomously turn the turning wheels is executed by the turning device (18) such that the vehicle travels along the lane even though the steering input member is not subjected to the steering operation by the driver. Further, when the steering operation of the steering input member by the driver is determined to be started during the execution of the autonomous turning control, the autonomous turning control is stopped and the steering guide torque control is started.

Accordingly, when the driver starts the steering operation of the steering input member during the execution of the autonomous turning control, it is possible to automatically stop the autonomous turning control and automatically start the steering guide torque control without requesting a switch operation or the like.

In the above description, in order to help the understanding of the present disclosure, the name and/or the reference numeral used in the embodiment are added in parentheses to the configuration of the disclosure corresponding to the embodiment described below. However, each component of the present disclosure is not limited to the component of the embodiment corresponding to the name and/or the reference numeral added in parentheses. Other objects, other features, and accompanying advantages of the disclosure will be readily understood from the description of embodiments of the disclosure described with reference to the following drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing an embodiment of a steering guide torque control device for a vehicle configured as a steering reaction force torque control device;

FIG. 2 is a diagram for describing an imaging reference position and the like;

FIG. 3 is a flowchart showing a routine for controlling steering reaction force torque according to a first embodiment;

FIG. 4 is a flowchart showing a routine for calculating target basic steering guide torque Tsgtb executed in step S70 of FIG. 3;

FIG. 5 is a flowchart showing the routine for controlling the steering reaction force torque according to a second embodiment;

FIG. 6 is a flowchart showing the routine for controlling the steering reaction force torque according to a third embodiment;

FIG. 7 is a flowchart showing a routine for calculating target steering guide torque Tsgt executed in step S100 of FIG. 6;

FIG. 8 is a flowchart showing the routine for controlling the steering reaction force torque according to a fourth embodiment;

FIG. 9 is a map for calculating a correction coefficient Ks based on an index value Nin;

FIG. 10 is a map for calculating the target basic steering guide torque Tsgtb based on a steering angle deviation Δθ;

FIG. 11 is a map for calculating a corrected steering angle Δθa based on the index value Nin;

FIG. 12 is a map for calculating the target steering guide torque Tsgt based on the steering angle deviation Δθ;

FIG. 13 is a diagram showing how the target steering guide torque Tsgt is modified in the first and second embodiments; and

FIG. 14 is a diagram showing how the target steering guide torque Tsgt is modified in the third and fourth embodiments.

### DETAILED DESCRIPTION OF EMBODIMENTS

Hereinafter, embodiments of the present disclosure will be described in detail with reference to accompanying drawings.

### First Embodiment

Configuration

As shown in FIG. 1, a steering guide torque control device 10 according to a first embodiment is configured as a steering reaction force torque control device including a steer-by-wire type steering device 12 and an electronic control unit 14 that controls the steering device 12 and is applied to a vehicle 60. In the first embodiment, as will be described in detail below, the steering guide torque control device 10 performs lane keeping control as autonomous turning control to autonomously turn turning wheels such that the vehicle 60 travels along a lane.

In the following description and drawings, the “electronic control unit” is denoted as an “ECU”. Further, “LKA” is an abbreviation for Lane Keeping Assist, and the “lane keeping control” is denoted as LKA control.

The steering device 12 includes a steering input device 16 and a turning device 18 that are not mechanically connected. The steering input device 16 includes a steering wheel 20, a steering angle detection device 22 that detects a rotation angle of the steering wheel as a steering angle θ, and a reaction force actuator 24 that applies steering reaction force torque Tre to the steering wheel.

The steering wheel 20 is a steering input member that is subjected to steering operation by a driver (not shown) and may have a form like a control wheel. The reaction force actuator 24 includes an electric motor, and a rotation shaft 26 of the electric motor is integrally connected to the steering wheel 20. The steering angle detection device 22 may be a rotary encoder built in the electric motor.

The turning device 18 includes a turning mechanism 30 configured to turn right and left front wheels 28FR, 28FL, which are the turning wheels, by receiving turning torque Tst, a turning actuator 32 that applies turning torque to the turning mechanism, and a rudder angle detection device 34 that detects a rudder angle δ of the turning wheels.

In the illustrated embodiment, the turning mechanism 30 includes a rack and pinion device 40 having a rack bar 36 and a pinion shaft 38. Although not shown in the figure, the pinion shaft 38 has a pinion that meshes with rack teeth of the rack bar 36. Thus, a rotational motion of the pinion shaft 38 is converted into a reciprocating motion of the rack bar 36, and the reciprocating motion of the rack bar 36 is converted into the rotational motion of the pinion shaft 38. The turning mechanism may have any structure known in the art.

Further, the turning mechanism 30 includes tie rods 42R, 42L, and inner ends of the tie rods 42R, 42L are pivotally attached to right and left tips of the rack bar 36, respectively. Although not shown in the figure, outer ends of the tie rods 42R, 42L are pivotally attached to knuckle arms of the front wheels 28FR, 28FL. The turning actuator 32 includes an electric motor, and a rotation shaft of the electric motor is integrally connected to the pinion shaft 38.

Accordingly, the turning mechanism 30 is configured to turn the front wheels 28FR, 28FL by receiving the turning torque from the turning actuator 32 at the pinion shaft 38. There is a certain relationship between a rotation angle φ (not shown) of the pinion shaft 38 and the rudder angle δ of the front wheels 28FR, 28FL. Accordingly, in the illustrated embodiment, the rudder angle detection device 34 detects the rotation angle φ of the rotation shaft of the electric motor of the pinion shaft 38 or the turning actuator 32 to detect the rudder angle δ of the front wheels 28FR, 28FL.

Although not shown in detail in FIG. 1, the ECU 14 includes a microcomputer and a drive circuit. The microcomputer has a CPU, a ROM, a RAM, an interface (I/F), and the like and has a general configuration in which the above parts are connected by a bidirectional common bus.

The ECU 14 receives a signal indicating the steering angle θ detected by the steering angle detection device 22 and a signal indicating the rudder angle δ of the front wheels 28FR, 28FL detected by the rudder angle detection device 34. Further, the ECU 14 receives a signal indicating a vehicle speed V detected by a vehicle speed sensor 44 and a signal indicating white line information of a lane in front of the vehicle 60 acquired by a camera sensor 46. The vehicle speed sensor 44 detects the vehicle speed V based on, for example, a wheel speed.

Further, the ECU 14 receives, from an LKA switch 48, a signal indicating whether or not the switch is on. When the LKA switch 48 is on, the ECU 14 executes the LKA control.

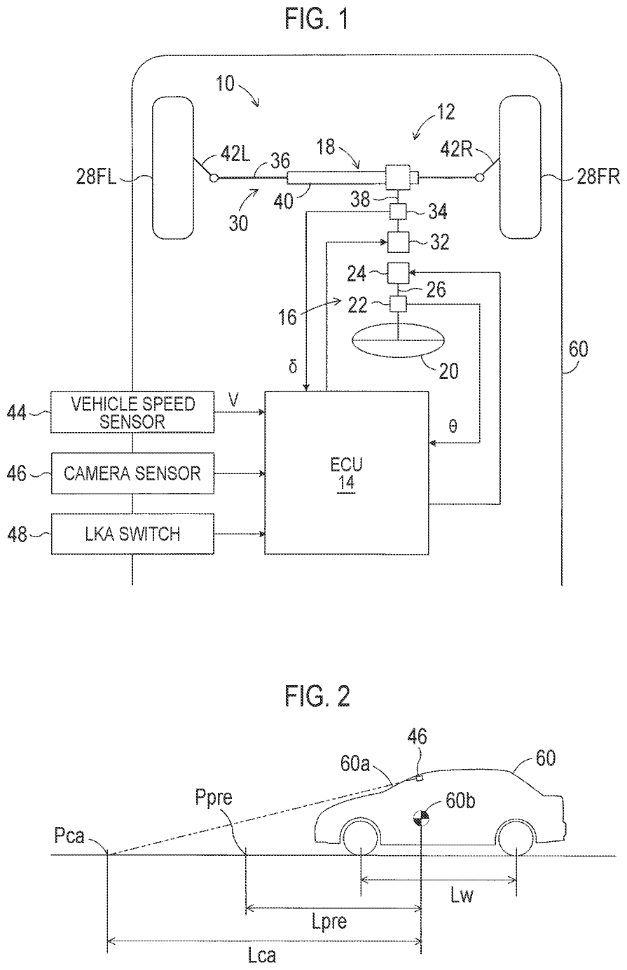

As shown in FIG. 2, the camera sensor 46 is fixed to an upper part of an inner surface of a windshield 60a of the vehicle 60 and captures an image in front of the vehicle 60 centering on an imaging reference position Pca at a distance Lca (positive constant) from the center of gravity 60b, which is a reference position of the vehicle 60, to the front. The distance Lca is referred to as an imaging reference distance Lca as needed. The reference position of the vehicle 60 may be positions of the front wheels 28FR, 28FL, intermediate positions of the front and rear wheels, and the like.

When the LKA switch 48 is off, the ECU 14 sets a steering gear ratio Rst to a standard steering gear ratio Rstn and controls the turning actuator 32 based on the steering angle θ detected by the steering angle detection device 22. Accordingly, the rudder angle δ of the front wheels 28FR, 28FL is controlled to be θ/Rstn. The steering angle θ and the rudder angle δ become zero when the vehicle 60 is in a straight-ahead state and become positive values when the vehicle 60 turns to the left. Further, the standard steering gear ratio Rstn is a positive value preset to increase as the vehicle speed V becomes higher and may be a positive constant.

Further, the ECU 14 calculates basic steering reaction force torque Treb requested to be applied to the steering wheel 20 based on the steering angle θ, a differential value of the steering angle θ, and a second-order differential value of the steering angle θ. The basic steering reaction force torque Treb is variably set according to the vehicle speed to increase as the vehicle speed V becomes higher. The basic steering reaction force torque Treb may be controlled in any manner known in the art. For example, the basic steering reaction force torque Treb may be torque corresponding to steering torque felt by the driver through the steering wheel in a vehicle in which the steering wheel is mechanically connected to the turning wheels and steering assist torque is applied by a power steering device.

The ECU 14 further calculates target steering guide torque Tsgt that guides the driver to steer when the vehicle 60 travels on a curve of a traveling road, as will be described in detail below. Further, the ECU 14 controls the reaction force actuator 24 such that the steering reaction force torque Tre, which is generated by the reaction force actuator 24 and applied to the steering wheel 20, becomes target steering reaction force torque Tret, which is a sum of the basic steering reaction force torque Treb and the target steering guide torque Tsgt. Accordingly, the reaction force actuator 24 functions as a torque applying device that applies steering guide torque Tsg corresponding to the target steering guide torque Tsgt to the steering wheel 20. The magnitude of the target steering guide torque Tsgt is about one-tenth of the magnitude of the basic steering reaction force torque Treb.

When the driver performs additional steering such that an actual steering angle θ is separated from a target steering angle θt, the target steering guide torque Tsgt acts in a direction of suppressing the steering. On the other hand, when the driver performs returning steering such that the actual steering angle θ approaches the target steering angle θt, the target steering guide torque Tsgt acts in a direction of promoting the steering. Accordingly, the target steering guide torque Tsgt guides the driver to steer such that the actual steering angle θ is within a predetermined range of the steering operation amount including the target steering angle θt.

In the embodiment, the ECU 14 calculates a curve curvature ρca of the traveling road for a region centered on the imaging reference position Pca based on the white line information of the lane in front of the vehicle 60 acquired by the camera sensor 46 and stores the calculated curvature in the RAM. Accordingly, the camera sensor 46 and the ECU 14 function as a detection device that detects the curve curvature ρca of the traveling road in the region centered on the imaging reference position Pca.

Further, the ECU 14 reads out the curve curvature ρca corresponding to a look-ahead time Δt from the RAM as a look-ahead curve curvature ρpre, calculates the target steering angle θt based on the curve curvature ρpre, and calculates the steering guide torque Tsg based on a deviation Δθ between the target steering angle θt and the actual steering angle θ. The target steering angle θt is a target steering angle for facilitating the actual steering angle to remain within an appropriate range such that the vehicle 60 travels along the curve. In the embodiment, a curvature in a direction in which the vehicle 60 turns to the left is positive.

The curve curvature ρca [1/m] is calculated according to the following equation (1). In the following equation (1), V is a vehicle speed [m/s], and ρ₀ is a curve curvature [1/m] of a traveling road at the center of gravity 60b of the vehicle 60. Accordingly, ρ₀ is the curve curvature ρca that is calculated before a time Lca/V requested for the vehicle 60 to travel over the imaging reference distance Lca shown in FIG. 1 and stored in the RAM. Δρ is a rate of change [1/m/m] of the curve curvature ρca calculated before the time Lca/V and stored in the RAM, that is, an amount of change in the curve curvature per unit distance.

ρca=ρ₀+VΔtΔρ (1)

As shown in FIG. 1, a distance (look-ahead distance) Lpre between the center of gravity 60b of the vehicle 60 and a look-ahead position Ppre is smaller than the imaging reference distance Lca. The look-ahead distance Lpre may not be constant. As can be seen from the above description, the curve curvature ρpre is a curve curvature at the look-ahead position Ppre, that is, a curve curvature at a position where the center of gravity 60b of the vehicle 60 reaches after the look-ahead time Δt.

The target steering angle θt [deg] is calculated according to the following equation (2). In the following equation (2), Rst is a steering gear ratio as described above, A is a stability factor of the vehicle 60 [deg/(m²/s²)], and Lw is a wheelbase of the vehicle 60. The stability factor A and the wheelbase Lw are known constant values determined by a specification of the vehicle 60.

θt=Rst(1+AV²)ρpreLw (2)

The ECU 14 calculates the steering angle deviation Δθ, which is a deviation θ−θt between the actual steering angle θ and the target steering angle θt, and refers to a map shown in FIG. 10 based on the steering angle deviation Δθ to calculate target basic steering guide torque Tsgtb.

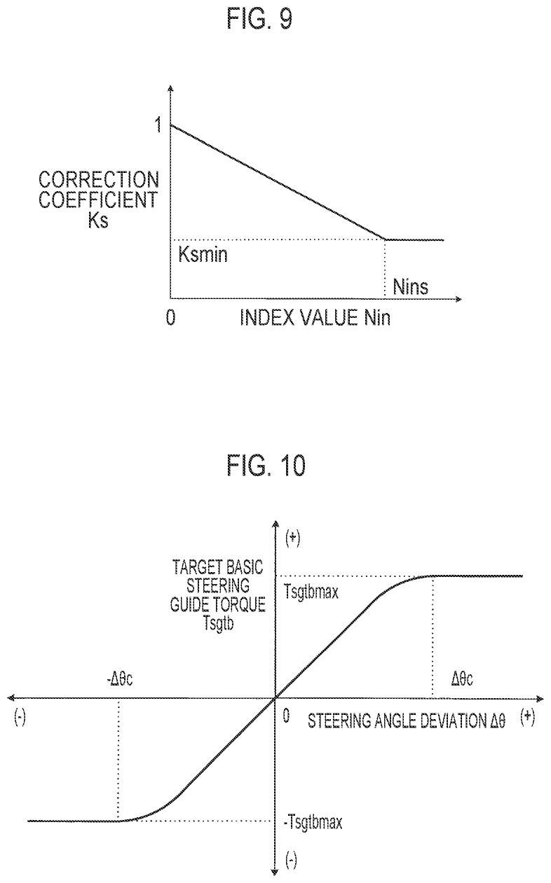

In particular, the ECU 14 performs the calculation with the number of times a difference between an absolute value of the actual steering angle θ and an absolute value of the target steering angle θt exceeds a reference value θa within a determination time Tc up to the present as an index value Nin. The ECU 14 refers to a map shown in FIG. 9 based on the index value Nin to calculate a correction coefficient Ks.

The determination time Tc may be constant. However, in the present embodiment and other embodiments described below, the determination time Tc is variably set according to a frequency at which the vehicle 60 performs curve traveling to be longer as the frequency at which the vehicle performs the curve traveling is lower. Further, the reference value θa may be constant. However, in the present embodiment and other embodiments described below, the reference value θa is variably set according to the vehicle speed to be smaller as the vehicle speed V is higher.

Further, the ECU 14 calculates the target steering guide torque Tsgt as a product KsTsgtb of the correction coefficient Ks and the target basic steering guide torque Tsgtb. Further, the ECU 14 controls the reaction force actuator 24 such that the steering reaction force torque Tre becomes the target steering reaction force torque Tret.

When the LKA switch 48 is on and the driver does not perform the steering operation, the ECU 14 executes the LKA control without executing the steering guide torque control. Further, when the driver performs the steering operation in a situation where the LKA switch 48 is on and the LKA control is executed, the ECU 14 stops the LKA control and executes the steering guide torque control.

Routine for Controlling Steering Reaction Force Torque

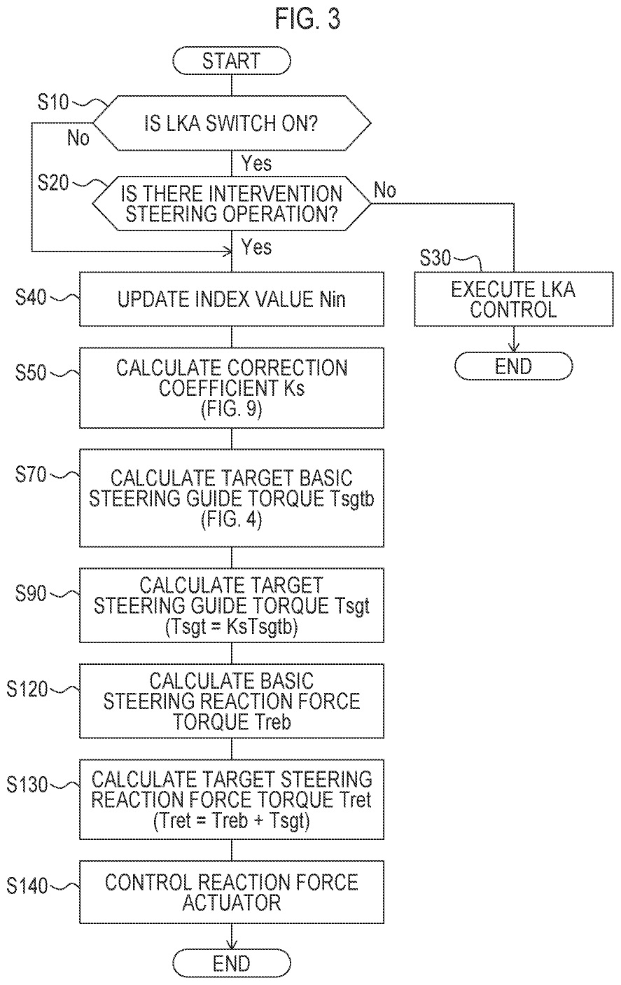

Next, a routine for controlling the steering reaction force torque of the first embodiment will be described. When an ignition switch (not shown in the figure) is on, the CPU of the ECU 14 executes the routine for controlling the steering reaction force torque shown in a flowchart of FIG. 3 every time a predetermined time elapses. A control program corresponding to the flowchart of FIG. 3 is stored in the ROM of the ECU 14.

First, in step S10, the CPU determines whether or not the LKA switch 48 is on. The CPU advances the control of the steering reaction force torque to step S40 when negative determination is made and advances the control of the steering reaction force torque to step S20 when positive determination is made.

In step S20, the CPU determines whether or not the driver performs the steering operation that intervenes in the LKA control. The CPU executes the LKA control in step S30 when the negative determination is made and advances the control of the steering reaction force torque to step S40 when the positive determination is made. The LKA control may be performed in any manner known in the art. The determination of whether or not the driver performs the steering operation that intervenes in the LKA control may be performed in any manner known in the art.

In step S40, the CPU decides the determination time Tc based on the frequency at which the vehicle 60 performs the curve traveling as described above and decides the reference value θa based on the vehicle speed V as described above. Further, the CPU performs the calculation with the number of times the difference between the absolute value of the actual steering angle θ and the absolute value of the target steering angle θt exceeds the reference value θa within the determination time Tc up to the present as the index value Nin.

In step S50, the CPU refers to the map shown in FIG. 9 based on the index value Nin to calculate the correction coefficient Ks. As shown in FIG. 9, the correction coefficient Ks is calculated to be 1 when the index value Nin is 0, to be smaller as the index value Nin is larger when the index value Nin is less than Nins (positive constant), and to be a constant value of Ksmin when the index value Nin is Nins or more.

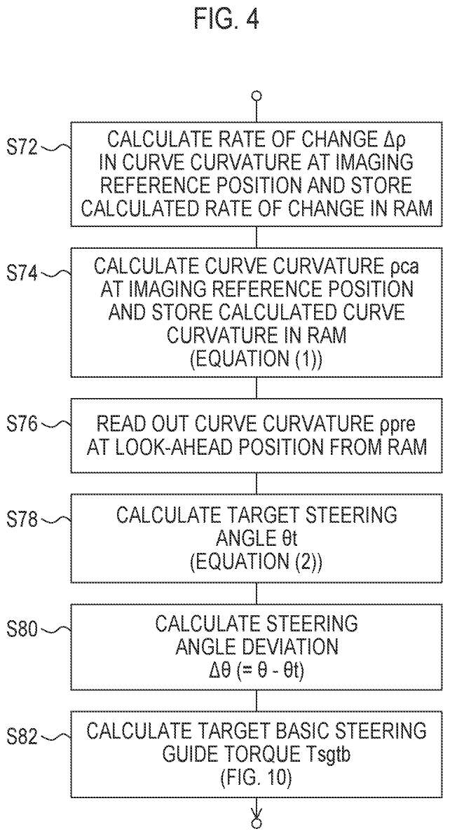

In step S70, the CPU calculates the target basic steering guide torque Tsgtb according to a flowchart shown in FIG. 4.

In step S90, the CPU calculates the target steering guide torque Tsgt that guides the driver to steer when the vehicle 60 travels on the curve of the traveling road as the product KsTsgtb of the correction coefficient Ks and the target basic steering guide torque Tsgtb.

In step S120, the CPU calculates the basic steering reaction force torque Treb requested to be applied to the steering wheel 20 in any manner known in the art based on the steering angle θ, the differential value of the steering angle θ, the second-order differential value of the steering angle θ, and the vehicle speed V.

In step S130, the CPU calculates the target steering reaction force torque Tret as a sum Treb+Tsgt of the basic steering reaction force torque Treb and the target steering guide torque Tsgt.

In step S140, the CPU controls the reaction force actuator 24 such that the steering reaction force torque Tre generated by the reaction force actuator 24 becomes the target steering reaction force torque Tret. Accordingly, the steering reaction force torque corresponding to the target steering reaction force torque Tret is applied to the steering wheel 20 to apply the steering guide torque Tsg corresponding to the target steering guide torque Tsgt to the steering wheel 20.

In step S72 of the flowchart shown in FIG. 4, the CPU calculates a rate of change Δρ in the curve curvature for the region centered on the imaging reference position Pca based on the white line information of the lane in front of the vehicle 60 acquired by the camera sensor 46 and stores the calculated rate of change in the RAM.

In step S74, according to the above equation (1), the curve curvature ρca of the traveling road is calculated for the region centered on the imaging reference position Pca and stored in the RAM. The curve curvature ρca may be set to 0 from the start of control until the time Lca/V elapses.

In step S76, the CPU reads out, from the RAM, the curve curvature ρca calculated before the look-ahead time Δt and stored in the RAM as the curve curvature ρpre at the look-ahead position Ppre.

In step S78, the CPU calculates the steering angle θt as a target steering operation amount for the vehicle 60 to travel along the curve of the traveling road according to the above equation (2) based on the vehicle speed V and the curve curvature ρpre at the look-ahead position Ppre.

In step S80, the CPU calculates the steering angle deviation Δθ, which is the deviation θ−θt between the actual steering angle θ detected by the steering angle detection device 22 and the target steering angle θt.

In step S82, the CPU refers to the map shown in FIG. 10 based on the steering angle deviation Δθ to calculate the target basic steering guide torque Tsgtb. As shown in FIG. 10, the target basic steering guide torque Tsgtb is calculated to be larger as an absolute value of the steering angle deviation Δθ is larger when the absolute value of the steering angle deviation Δθ is less than Δθc (positive constant) and is calculated to be a constant value of Tsgtbmax when the absolute value of the steering angle deviation Δθ is Δθc or more.

### Second Embodiment

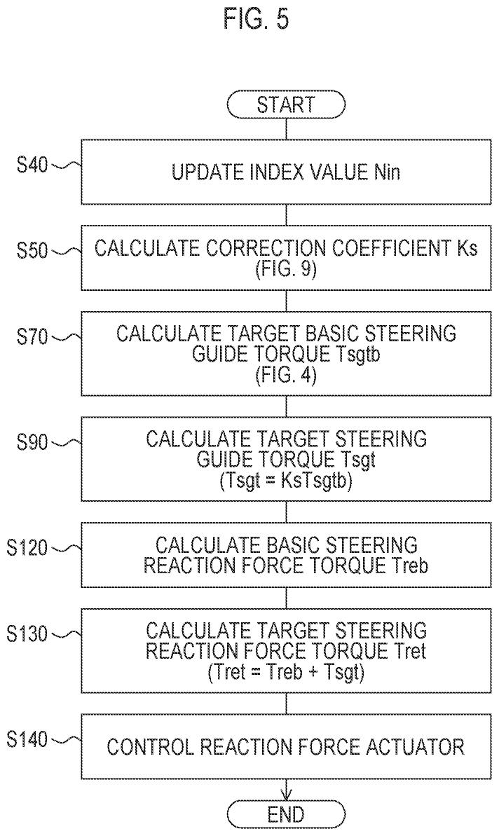

FIG. 5 is a flowchart showing the routine for controlling the steering reaction force torque in a second embodiment configured as a modification example of the first embodiment. In FIG. 5, the same step number as the step number assigned in FIG. 3 is assigned to the same step as the step shown in FIG. 3. This also applies to other embodiments described below.

In the second embodiment and a fourth embodiment described below, the LKA control is not executed. Accordingly, although not shown, the steering guide torque control device 10 according to these embodiments is not provided with the LKA switch 48.

As can be seen from the comparison between FIGS. 5 and 3, steps S10 to S30 in the first embodiment are not executed, and steps S40 to S140 are executed in the same manner as steps S40 to S140 in the first embodiment, respectively.

According to the first and second embodiments, the number of times the difference between the absolute value of the actual steering angle θ and the absolute value of the target steering angle θt exceeds the reference value θa within the determination time Tc up to the present is calculated as the index value Nin (step S40). The correction coefficient Ks is calculated based on the index value Nin (step S50), and the target basic steering guide torque Tsgtb is calculated (step S70). Further, the target steering guide torque Tsgt is calculated as the product KsTsgtb of the correction coefficient Ks and the target basic steering guide torque Tsgtb (step S90).

Since the correction coefficient Ks is calculated to be smaller as the index value Nin is larger (FIG. 9), a ratio of the target steering guide torque Tsgt to the deviation Δθ decreases as the index value Nin is larger. Therefore, the magnitude of the target steering guide torque can be smaller as the tendency of the driver to perform the curve traveling different from the curve traveling by the target steering angle.

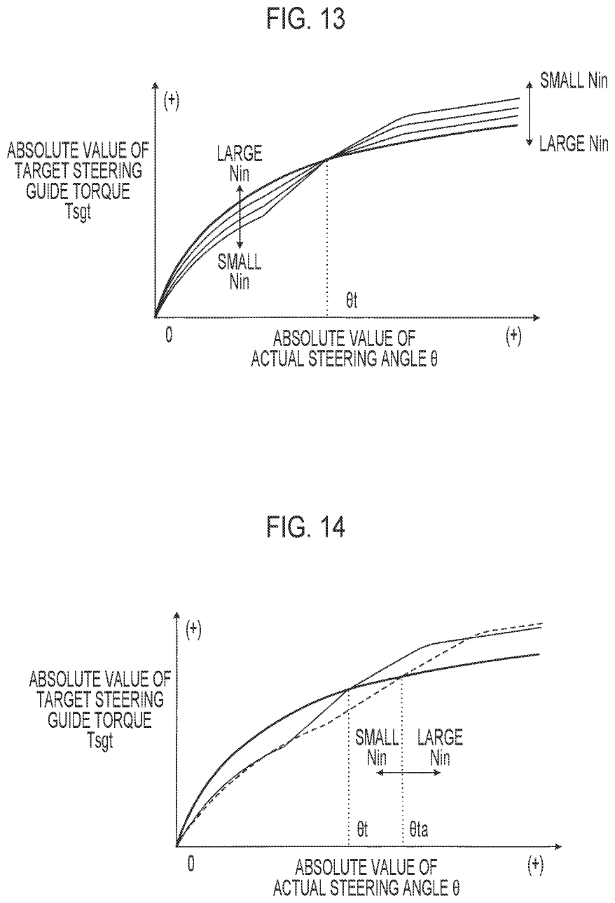

FIG. 13 shows a relationship between the absolute value of the actual steering angle θ, the index value Nin, and an absolute value of the target steering guide torque Tsgt. As shown in FIG. 13, the magnitude of the target steering guide torque Tsgt in the region where the magnitude of the actual steering angle θ exceeds the magnitude of the target steering angle θt becomes smaller as the index value Nin is larger. As can be seen from FIG. 13, when the steering operation is performed such that the magnitude of the actual steering angle θ becomes larger than the magnitude of the target steering angle θt, the reaction force torque generated due to the steering guide torque can be smaller as the index value Nin is larger.

### Third Embodiment

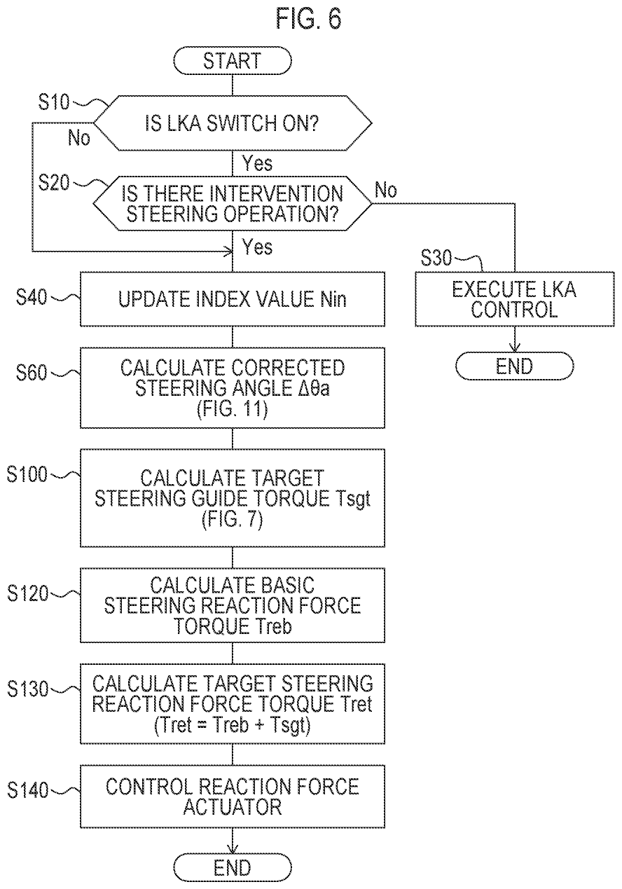

FIG. 6 is a flowchart showing the routine for controlling the steering reaction force torque according to a third embodiment of the present disclosure.

As can be seen from the comparison between FIG. 6 and FIG. 3, in the second embodiment, steps S10 to S40 and steps S120 to S140 are executed in the same manner as in the first embodiment. When step S40 is completed, steps S60 and S100 are executed.

In step S60, the CPU refers to a map shown in FIG. 11 based on the index value Nin to calculate a corrected steering angle Δθa. As shown in FIG. 11, the corrected steering angle Δθa is calculated to be 0 when the index value Nin is 0, to be smaller as the index value Nin is larger when the index value Nin is less than Nina (positive constant), and to be a constant value of Δθamax when the index value Nin is Nina or more.

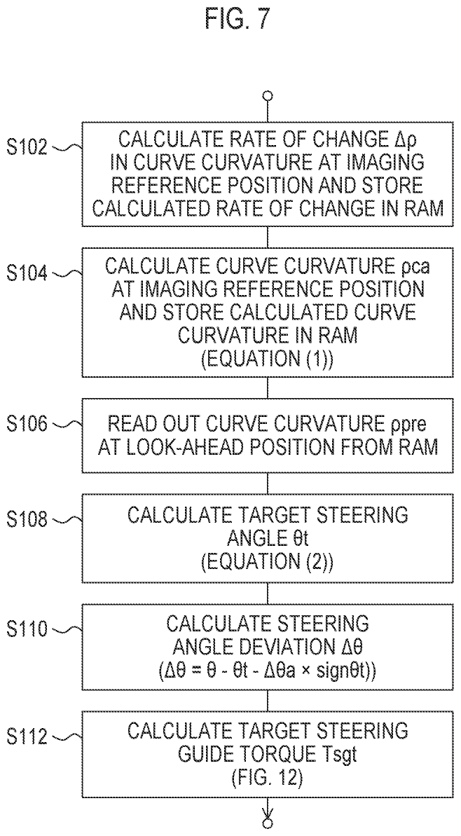

In step S100, the CPU calculates the target steering guide torque Tsgt according to a flowchart shown in FIG. 7.

As can be seen from the comparison between FIGS. 7 and 4, steps S102 to S108 are executed in the same manner as steps S72 to S78 of the first embodiment, respectively.

In step S110 executed after step S108, the steering angle deviation Δθ is calculated according to the following equation (3) with sign θt as a sign of the target steering angle θt. That is, the steering angle deviation Δθ is calculated as a deviation θ−(θt+Δθa×sign θt) between the actual steering angle θ detected by the steering angle detection device 22 and a target steering angle θta (=θt+Δθa×sign θt) of which magnitude is increasingly corrected by the corrected steering angle Δθa.

$$Δ θ = θ - ( θ t + Δθ a \times sign θ t ) \qquad ( 3 )$$

$$= θ - θ t - Δθ a \times sign θ t$$

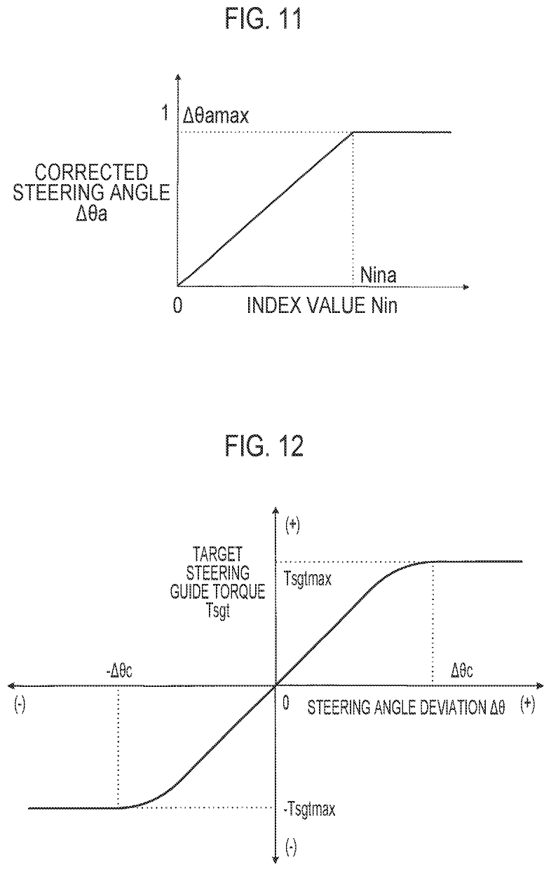

In step S112, the CPU refers to a map shown in FIG. 12 based on the steering angle deviation Δθ to calculate the target steering guide torque Tsgt. As shown in FIG. 12, the target steering guide torque Tsgt is calculated to be larger as the absolute value of the steering angle deviation Δθ is larger when the absolute value of the steering angle deviation Δθ is less than Δθc and to be a constant value of Tsgtmax when the absolute value of the steering angle deviation Δθ is Δθc or more.

### Fourth Embodiment

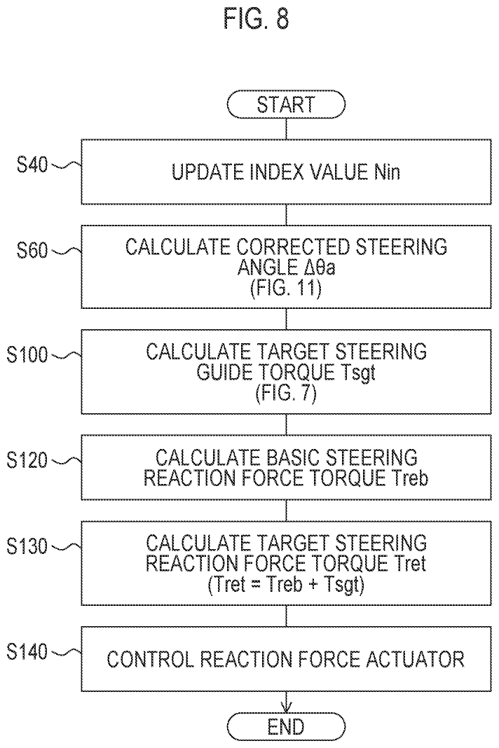

FIG. 8 is a flowchart showing the routine for controlling the steering reaction force torque in the fourth embodiment configured as a modification example of the third embodiment.

As can be seen from the comparison between FIGS. 8 and 6, steps S10 to S30 in the third embodiment are not executed, and steps S40 to S140 are executed in the same manner as steps S40 to S140 in the third embodiment, respectively.

According to the third and fourth embodiments, the number of times the difference between the absolute value of the actual steering angle θ and the absolute value of the target steering angle θt exceeds the reference value θa within the determination time Tc up to the present is calculated as the index value Nin (step S40). The corrected steering angle Δθa is calculated based on the index value Nin (step S60), and the target steering guide torque Tsgt is calculated according to the flowchart shown in FIG. 7 (step S100).

The steering angle deviation Δθ is calculated as a deviation between the actual steering angle θ and the target steering angle θt+Δθa×sign θt of which magnitude is increasingly corrected by the corrected steering angle Δθa (step S110). Accordingly, the magnitude of the target steering guide torque Tsgt when the magnitude of the actual steering angle θ becomes larger than the magnitude of the target steering angle that is not increasingly modified can be smaller.

According to the first and third embodiments described above, when the driver performs the steering operation that intervenes in the LKA control in a situation where the LKA switch 48 is on, positive determination is made in steps S10 and S20, and steps S40 to S140 are executed. Accordingly, when the driver starts the intervention steering operation during the execution of the LKA control, the LKA control can be automatically stopped and the steering guide torque control can be automatically started without requesting the switch operation or the like.

### Effects Common to First to Fourth Embodiments

As can be seen from the above description, according to the first to fourth embodiments described above, the target steering guide torque can be modified according to the index value such that the magnitude of the target steering guide torque Tsgt becomes smaller as the index value Nin is larger. Accordingly, compared with a case where the target steering guide torque is not modified according to the index value, it is possible to reduce a risk that the driver feels a sense of discomfort of increasing in the steering reaction force due to the steering guide torque when the vehicle performs the curve traveling.

Further, according to the first to fourth embodiments, the determination time Tc is variably set according to the frequency at which the vehicle performs the curve traveling such that the determination time becomes longer as the frequency at which the vehicle 60 performs the curve traveling is longer. Accordingly, it is possible to calculate the index value as a value indicating the tendency of the driver to perform the steering operation such that the actual steering angle is different from the target steering angle, regardless of the number of curves on the traveling road.

Further, according to the first to fourth embodiments, the reference value θa is variably set according to the vehicle speed such that the reference value becomes smaller as the vehicle speed V is higher. Accordingly, it is possible to calculate the index value as the value indicating the tendency of the driver to perform the steering operation such that the actual steering angle is different from the target steering angle, regardless of the magnitude of a turning radius of the curve.

In the above, the present disclosure has been described in detail with the specific embodiments, but is not limited to the above embodiments. The fact that various other embodiments are possible within the scope of the present disclosure is apparent to those skilled in the art.

For example, in the above embodiment, the index value Nin is calculated as the number of times the difference between the absolute value of the actual steering angle θ and the absolute value of the target steering angle θt exceeds the reference value θa within the determination time Tc up to the present. However, the index value Nin may be calculated as an integrated time in which the difference between the absolute value of the actual steering angle θ and the absolute value of the target steering angle θt exceeds the reference value θa within the determination time Tc up to the present. Further, with the number of times and the integration time each as Nc and Tc, α and β as positive constants, the index value Nin may be calculated as a linear sum αNc+βTc of the number of times and the integration time based on both the number of times and the integration time.

In the above embodiment, the autonomous turning control to autonomously turn the turning wheels (28FR, 28FL) by the turning device (18) such that the vehicle (60) travels along the lane even though the driver does not perform the steering operation on the steering input member (steering wheel 20) is the LKA control. However, the autonomous turning control may be any autonomous turning control known in the art, such as autonomous driving control.

Further, in the first and third embodiments described above, when the driver performs the steering operation that intervenes in the LKA control, the LKA control is stopped and the steering guide torque control in steps S40 to S140 is automatically started. However, the steering guide torque control that is started when the driver performs the steering operation that intervenes in the LKA control may be the steering guide torque control in which the target steering guide torque is not modified according to the index value.

Further, in the above embodiment, the steering guide torque control device 10 is configured as a steering reaction force torque control device including the steer-by-wire type steering device 12. However, the steering guide torque control device 10 may be configured as a steering reaction force torque control device in which the steering wheel and right and left front wheels are mechanically connected and that includes an electric power steering device. In that case, target steering assist torque Tsat is calculated as a sum of basic steering assist torque Tsab calculated based on the steering torque and the vehicle speed and the target steering guide torque Tsgt. Further, the electric power steering device is controlled such that steering assist torque Tsa generated by the electric power steering device becomes the target steering assist torque Tsat.

What is claimed is:

1. A steering guide torque control device for a vehicle, the steering guide torque control device comprising:
a steering input member that is subjected to steering operation by a driver;
a turning device that turns turning wheels according to a steering operation amount applied to the steering input member;
a torque applying device that applies steering guide torque to the steering input member;
a control unit that controls the torque applying device; and
an imaging device that acquires an image in front of the vehicle, wherein:
the control unit is configured to estimate a curvature of a lane in front of the vehicle for causing the vehicle to travel along the lane based on the image acquired by the imaging device, calculate a target steering operation amount based on the curvature of the lane, calculate target steering guide torque for guiding the driver to steer such that an actual steering operation amount is within a predetermined range of the steering operation amount including the target steering operation amount based on a deviation between the target steering operation amount and the actual steering operation amount, and perform steering guide torque control to control the torque applying device such that the steering guide torque becomes the target steering guide torque; and
the control unit is configured to obtain an index value indicating at least one of the number of times or an integrated time in which a difference between a magnitude of the actual steering operation amount and a magnitude of the target steering operation amount exceeds a reference value within a determination time up to the present and modify the target steering guide torque according to the index value such that a magnitude of the target steering guide torque becomes smaller as the index value is larger.

2. The steering guide torque control device according to claim 1, wherein the control unit is configured to reduce a ratio of the target steering guide torque to the deviation as the index value is larger.

3. The steering guide torque control device according to claim 2, wherein the control unit is configured to increasingly modify the magnitude of the target steering operation amount with a modification amount that becomes larger as the index value is larger.

4. The steering guide torque control device according to claim 1, wherein the control unit is configured to variably set the determination time according to a frequency at which the vehicle performs curve traveling such that the determination time becomes longer as the frequency at which the vehicle performs the curve traveling is lower.

5. The steering guide torque control device according to claim 4, wherein the control unit is configured to acquire information on a vehicle speed and to variably set the reference value according to the vehicle speed such that the reference value becomes smaller as the vehicle speed is higher.

6. The steering guide torque control device according to claim 1, wherein the control unit is configured to execute autonomous turning control to autonomously turn the turning wheels by the turning device such that the vehicle travels along the lane even though the steering input member is not subjected to the steering operation by the driver and to stop the autonomous turning control and start the steering guide torque control when the steering operation of the steering input member by the driver is determined to be started during the execution of the autonomous turning control.
